(19) United States
(12) Patent Application Publication
(10) Pub. No.: US 2004/0158447 A1
(43) Pub. Date: Aug. 12, 2004

(54) Method for simulating and modeling the presence and growth of microbes, including pathogens and spoilage organisms, through a food supply chain

(75) Inventors: Lynn Leger, Mississauga (CA); Defne Berkin, Toronto (CA)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(73) Assignee: DuPont Canada Inc., Mississauga (CA)

(21) Appl. No.: 10/360,856

(22) Filed: Feb. 7, 2003

(51) Int. Cl. G06G 7/48; G06G 7/58

(52) U.S. Cl. 703/11

(57) ABSTRACT

A method is provided for simulating and modeling the presence and growth of a microbe, including a pathogen or spoilage organism, in a food product through a food supply chain. The food supply chain includes a plurality of major food handling steps, a plurality of food processing steps within each of the major food handling steps and a plurality of parameters relating to the food supply chain and the microbe. The method is carried out in a digital processor and comprising the steps of:

(a) providing a set of initial values for the major food handling steps in a data storage area;

(b) providing a set of initial values for the food processing steps in a data storage area;

(c) providing a set of initial values for the parameters in the data storage area;

(d) providing a set of equations that relate at least two of the parameters to each other;

(e) varying one or more of the initial values of the major food handling steps, the food processing steps or the parameters;

(f) executing a simulation routine, by the digital processor, using the set of equations to determine a second set of values for the parameters resulting from varying one or more of the initial values of the major food handling steps, the food processing steps or the parameters;

(g) storing the second set of values in the data storage area; and

(h) displaying one or more of the second set of values.

### FIELD OF THE INVENTION

This invention relates to a method for simulating and modeling the presence and growth of microbes, including pathogens and spoilage organisms, through a food supply chain, and in particular, to a method of determining how various parameters in the food supply chain are affected by a change to one or more parameters.

### BACKGROUND OF THE INVENTION

According to the Centers for Disease Control & Prevention (CDC), it is estimated that 76 million people develop food poisoning each year in the United States alone (see U.S. Pat. No. 6,461,608), and that about 5,000 die as a result. The presence of microbial pathogens in the food supply chain not only affect the health of the local population, but also represent a potential for spread of these organisms to visitors to the country and to consumers in countries that import food products.

Prevention of foodborne illnesses by microbial contamination is of major concern to the food processing industry, regulatory agencies, and consumers. Foodborne microbial contamination occurs both prior to entry into the processing facility, by contamination in the processing environment, and may also occur as a result of events after the food product is made. It is desirable, therefore, to reduce the occurrence and number of foodborne microbes in the food chain. Many means are available for reducing microbial contamination, and antimicrobial treatments are an important component of a food processor's plans to keep microbial growth in check.

In particular, poultry and meat processors have encountered major difficulties in detecting, preventing and removing microorganisms that contaminate poultry and meat tissues intended as food products. Of particular concern are Campylobacter, Salmonella, Listeria and pathogenic E. coli bacteria. Although E. coli bacteria are a major component of normal intestinal flora, certain pathogenic E. coli bacteria can cause enteric disease. E. coli 0157:H7 bacteria produce a toxin in the intestines that can cause anything from a mild diarrhoea to severe hemorrhagic colitis, where the cells of the intestinal lining are damaged, allowing blood to pass into stool. E. coli 0157:H7 is found regularly in the feces of healthy cattle, and is transmitted to humans through contaminated food, water, and direct contact with infected people or animals. During the slaughter process, intestinal fluid or feces of infected cattle can drip onto the surface of the meat, contaminating it. The harmful bacteria on the surface of the raw meat can become mixed throughout the meat during the grinding process, where it can better survive the heat of cooking. One hamburger patty can contain the meat from many cows.

Certain spoilage organisms, such as Lactobacillus spp., Pseudomonas spp. and Streptococcus spp. can affect the quality of food products by producing rancidity and off-odours. Currently, food processors typically sample food products or raw materials at specific stages in the food supply chain. In addition, environmental sites are also sampled. If abnormally high levels of contamination are found or a pathogen is detected, remedial steps are taken. Various intervention strategies are available to treat food at different stages of production and to sanitize the environment to reduce microbial loads, including irradiation (the treatment of foods by subjecting them to ionizing radiation), pasteurization, chemical treatments (the use of chlorine or chlorine dioxide, ozone, hydrogen peroxide, lactic acid, sodium carbonate, trisodium phosphate, and electrical stimulation) and Ultra Violet light.

In the food supply chain, there is potentially a large number of factors or parameters that may affect the presence and growth of microorganisms. Many of these parameters are inter-related so that a change in one or more parameters can significantly affect the others and impact the growth of organisms. Most processed foods are now provided with “best before” dates, which reflect on food quality. A variation in one or more parameters can also potentially have a significant effect on this “best before” date.

There is a need for a simulation model of a food supply chain that allows the manipulation of various parameters, such as temperature or water usage, to see how changes made within a food supply chain can affect the quality and safety of the products. This model provides the advantage of simulating changes, before they are implemented, to get a better understanding of the impact of the changes on the overall food supply chain. The present invention provides such a simulation model.

The disclosures of all patents/applications referenced herein are incorporated herein by reference.

### SUMMARY OF THE INVENTION

In accordance with one aspect of the present invention, there is provided, in a digital processor, a method for simulating and modeling the presence and growth of a microbe in a food product through a food supply chain, wherein the food supply chain comprises a plurality of major food handling steps, a plurality of food processing steps within each of the major food handling steps and a plurality of parameters relating to the food supply chain and the microbe, the method comprising the steps of:

(a) providing a set of initial values for the major food handling steps in a data storage area;

(b) providing a set of initial values for the food processing steps in a data storage area;

(c) providing a set of initial values for the parameters in the data storage area;

(d) providing a set of equations that relate at least two of the parameters to each other;

(e) varying one or more of the initial values of the major food handling steps, the food processing steps or the parameters;

(f) executing a simulation routine, by the digital processor, using the set of equations to determine a second set of values for the parameters resulting from varying one or more of the initial values of the major food handling steps, the food processing steps or the parameters;

(g) storing the second set of values in the data storage area; and

(h) displaying one or more of the second set of values.

### BRIEF DESCRIPTION OF THE DRAWINGS

The preferred embodiments of the present invention will be described with reference to the accompanying drawings in which like numerals refer to the same parts in the several views and in which:

FIG. 1 is a block flow chart showing various steps of the method of the present invention;

FIG. 2a to 2d is code for implementing examples of equations for use with a preferred embodiment of the present invention

FIG. 3 is a block flow chart showing various steps relating to processing steps at a farm, in accordance with a preferred embodiment of the present invention;

FIG. 4 is a block flow chart showing various steps relating to processing steps at a food processing plant, in accordance with a preferred embodiment of the present invention;

FIG. 5 is a block flow chart showing various steps relating to processing steps at a retailer, in accordance with a preferred embodiment of the present invention; and

FIG. 6 is a block flow chart showing various steps relating to processing steps taken by a consumer, in accordance with a preferred embodiment of the present invention.

### DETAILED DESCRIPTION OF THE PREFERRED EMBODIMENTS

The preferred embodiments of the present invention will now be described with reference to the accompanying figures.

In its general sense, the present invention provides a simulation or model for predicting the presence and growth of a microorganism in the food supply chain. The simulation model is carried out by a digital processor, and provides a method for simulating and modeling the presence and growth of a microorganism in a food product through a food supply chain, wherein the food supply chain comprises a plurality of major food handling steps, a plurality of food processing steps within each of the major food handling steps and a plurality of parameters relating to the food supply chain and the microbe. The method includes the following steps:

(a) providing a set of initial values for the major food handling steps in a data storage area;

(b) providing a set of initial values for the food processing steps in a data storage area;

(c) providing a set of initial values for the parameters in the data storage area;

(d) providing a set of equations that relate at least two of the parameters to each other;

(e) varying one or more of the initial values of the major food handling steps, the food processing steps or the parameters;

(f) executing a simulation routine, by the digital processor, using the set of equations to determine a second set of values for the parameters resulting from varying one or more of the initial values of the major food handling steps, the food processing steps or the parameters;

(g) storing the second set of values in the data storage area; and

(h) displaying one or more of the second set of values.

The present method allows a user to predict how various performance measures in any food supply chain are affected by a change in the values of one or more such parameters. The present method is particularly useful in simulating and modeling the presence and growth of microbes in a meat processing supply chain, which includes the major food handling steps of: raising cattle on a farm; delivery and slaughter of cattle at an abattoir which may or may not be associated with a processing plant; delivery and processing of the meat at a processing plant; delivery and storage of the processed meat at a retailer; and transportation, preparation and consumption of the processed meat by a consumer. It will be understood, however, that the present invention can also be used for simulating and modeling the presence and growth of microbes in other food segments and supply chains, such as: the processing and packaging of poultry, and pork; the growth, processing, packaging and sale of processed foods such as seafood, cereal, confections, cooked, frozen and canned foods; the growth, processing, packaging, sale and consumption of fresh produce; the provision, preparation and sale of foods at a restaurant chain; and the preparation, delivery, sale and consumption of dairy products which may include cultured, industrial, fluid and ice cream.

The present invention will now be described with reference to one of its preferred embodiments, namely the simulation and modeling of the presence and growth of a microbe in a meat processing supply chain.

The preferred simulation method of the present invention may be implemented on any suitable software platform. Preferably, the software platform used is ProModel™ Optimization Software Suite available from PROMODEL Corporation, 1875 S. State Street, Suite 3400, Orem, Utah 84097. ProModel™ Optimization Software is simulation-based software useful for evaluating, planning or designing manufacturing, warehousing, logistics and other operational and strategic applications. It provides a platform on which simulations can be built, including computer representations and test scenarios. Animation and graphical reports can then be generated for visualizing, understanding and improving various processes.

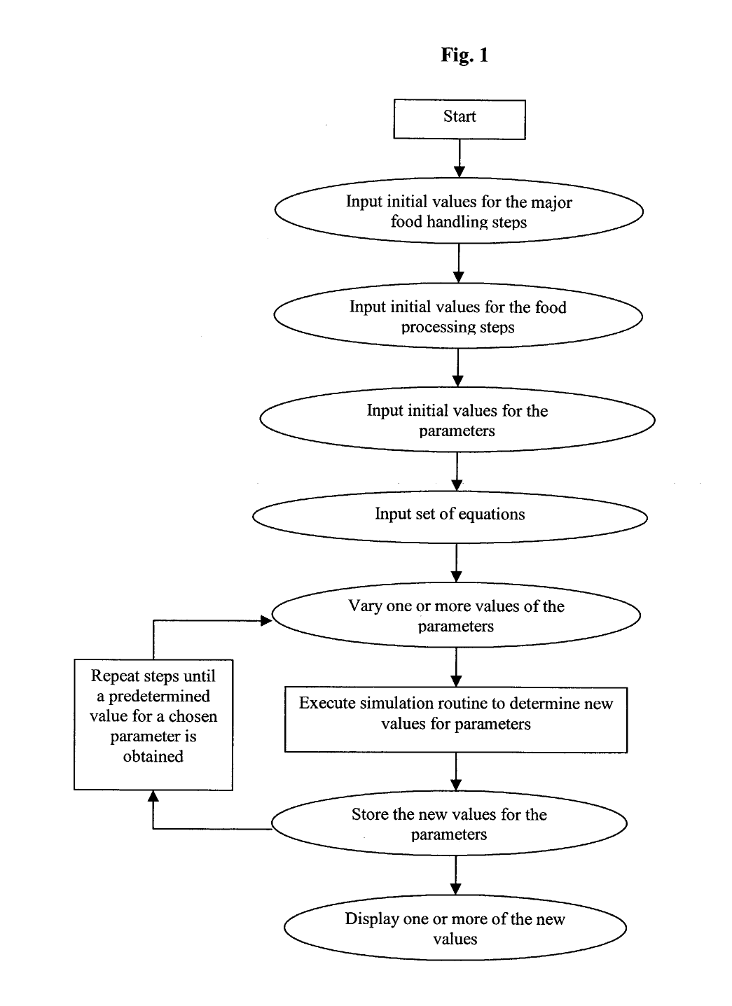

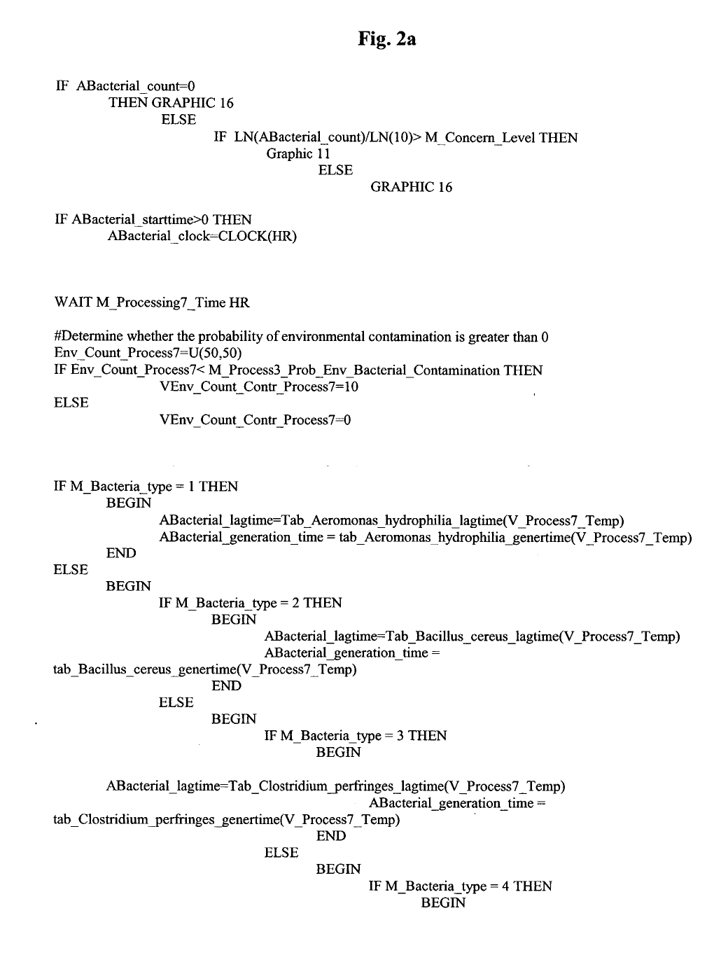

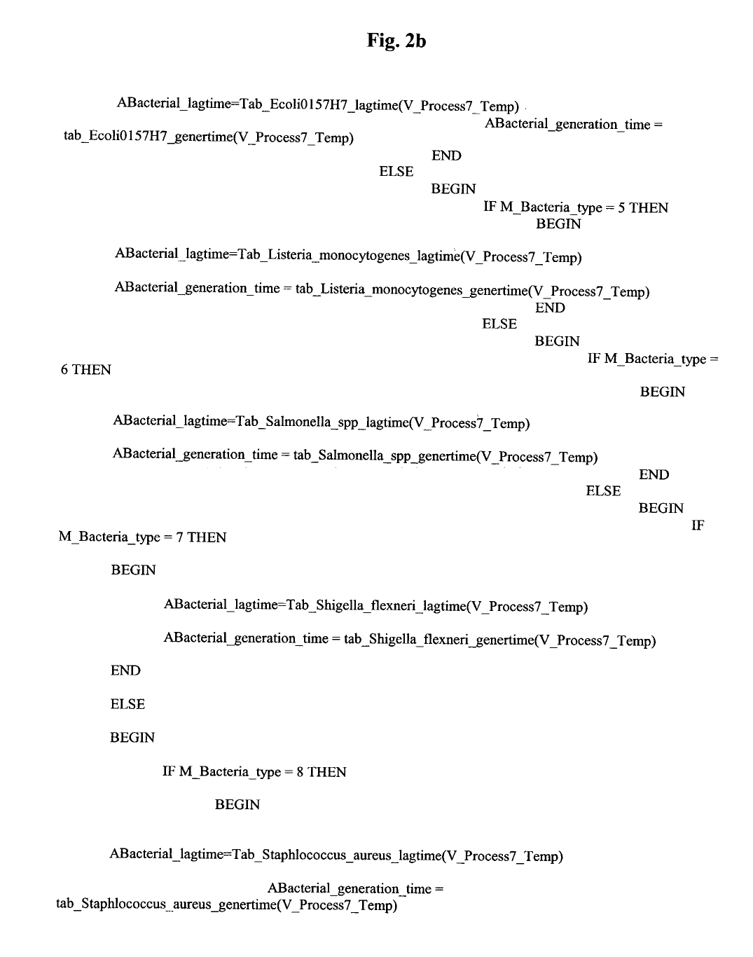

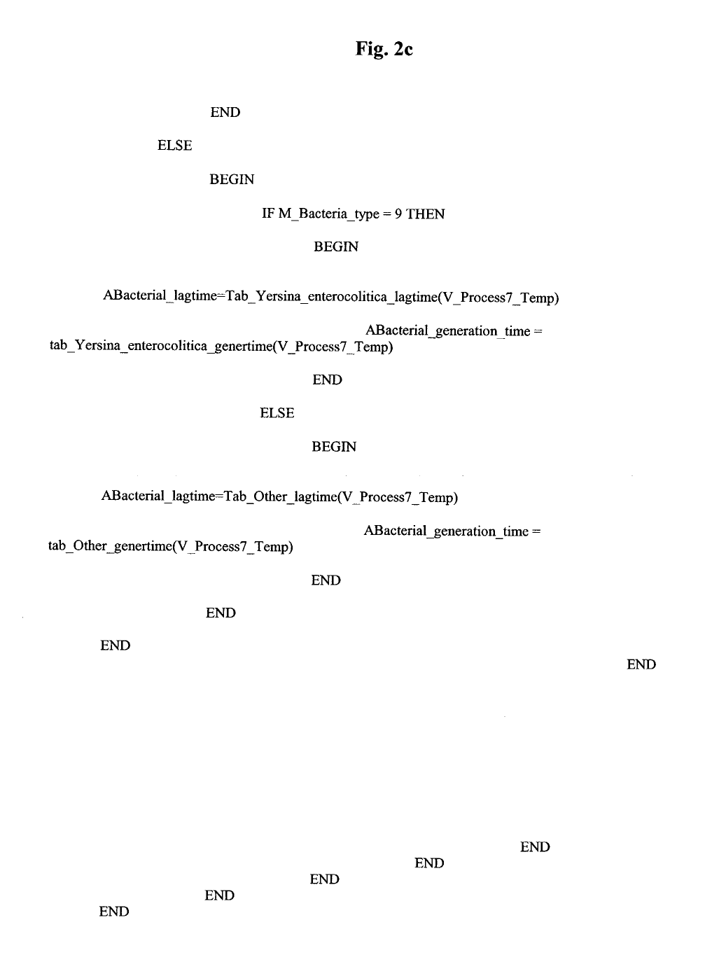

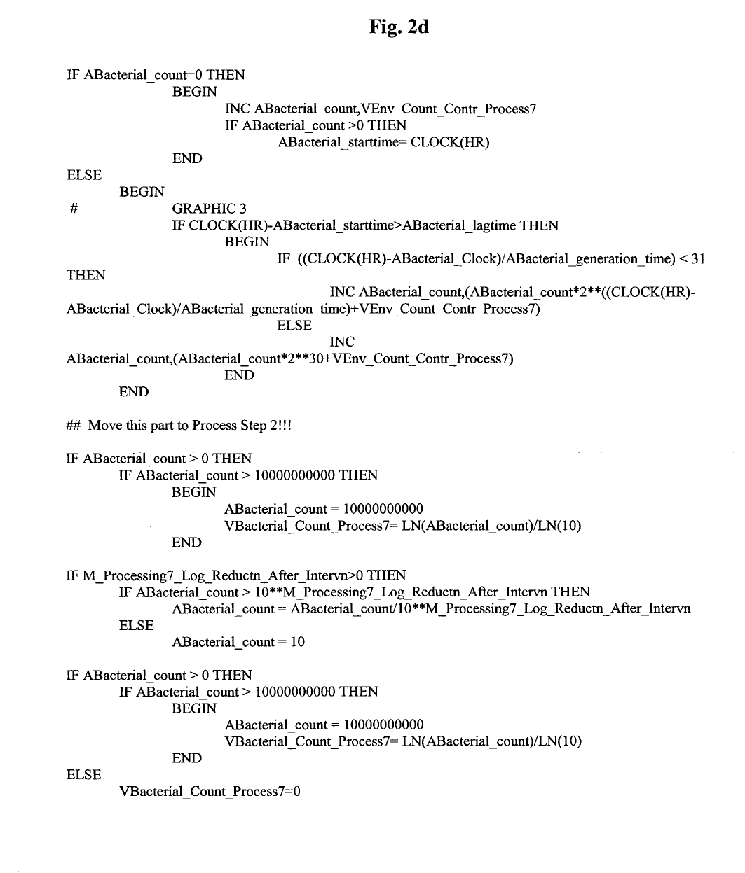

FIG. 1 is a block flow diagram illustrating the major steps in a preferred embodiment of the method of the present invention. As a first step, a set of initial values for the major food handling steps is provided and stored in a data storage area. In the case of a typical meat processing supply chain, the major food handling steps are the farm, the processing plant, the retailer and the consumer. These major food handling steps will be described in more detail below with reference to FIGS. 2 through 5.

The second step in the method is to provide a set of initial values for the food processing steps, which are stored in a data storage area. The food processing steps are the various activities that are performed on the food within the major food handling steps. Examples include the slaughter of cattle, transportation to the processing plant, storage in a warehouse, food preparation by a consumer, etc.

The third step is to provide a set of initial values for the parameters relating to the food supply chain and microbes. The main parameter of interest is temperature of the food product at various processing steps, including pasteurization and cold chain. Other parameters include time/growth data for the microbe, shift schedules for employees, particular equipment used, etc.

The fourth step is to provide to the storage area a set of equations that relate at least two of the parameters to each other. Preferably, the equations are in the form of mathematical formulae, however, they may also be in the form of look-up tables. In the case of the preferred method, equations that may be provided include an equation to determine the levels of microbes as a function of temperature; an equation to determine profitability of the food supply chain; an equation to determine production yields. Examples of such equations are as follows:

Bacterial generation time and lagtime tables for the microbe of interest are obtained. Every 4 hours, the temperature at each process step, including location, warehouse, and truck is generated randomly from a distribution, with given mean and variance. Then, based on the type of microbe of interest, the generation time and lagtime are looked up in the table corresponding to the particular microbe. If the elapsed time so far is longer than the lagtime, then the microbial count is calculated as:

ABacterial_Count(Beginning time of the step)+(ABacterial_count*2**((CLOCK(HR)−ABacterial_Clock)/ABacterial_generation_time)+Environmental count contributed by the environment at that step

This equation is used to update the microbial count at each step, based on the type of microbe, temperature and the elapsed time. Another set of updates is carried out at each step, depending on whether there is microbial intervention at that step. At each step throughout the food supply chain, the user has the option of having or not having microbial intervention. If there is microbial intervention at a particular step, then the microbial count is reduced by a number based on the nature of intervention, as follows:

IF M_Step1_Log_Reductn_After_Intervn>0 THEN

IF ABacterial_count>10**M_Step1_Log_Reductn_After_Intervn THEN

ABacterial_count=ABacterial_count/10**M_Step1_Log_Reductn_After_Intervn

ELSE

ABacterial_count=10

For example, cooking of a food product by a consumer can be considered as a type of intervention as a result of which the microbial count is reduced by 10⁶.

The above 2 sets of equations are the main ones used to update the microbial count through the steps in the supply chain. The code for implementing these equations is shown in FIG. 2a to 2d. Other equations that may be used are mainly to update the operational and financial performance metrics.

Once all the initial values and equations are provided, one or more of the initial values of the major food handling steps, the food processing steps or the parameters are varied. The simulation routine is then executed by the digital processor using the set of equations to determine a second set of values for the parameters resulting from varying one or more of the initial values of the major food handling steps, the food processing steps or the parameters. In other words, the simulation routine determines how the values of other parameters within the food supply chain are affected if the values of one or more parameters are changed. This is done using the set of equations that relate one or more parameters to other parameters.

The calculated second set of values is then stored in the data storage area, and one or more of the second set of values may then be displayed to the user. Preferably, the steps of varying the values of the parameters, executing the simulation routine and determining the new second set of values are repeated until a predetermined value for a chosen parameter is determined.

The plurality of parameters relating to the food supply chain and the microbe preferably includes three main types of parameters: those relating to the time/growth data for the microbe, those relating to economic data of the food supply chain and those relating to process steps data.

A. Time/Growth Data for the Microbe:

The time/growth data for the microbe includes one or more specific microbial parameters. First, the type of microbe of interest is determined and selected. Any microbe that may affect the safety or shelf life of food may be used. Examples include Salmonella, Listeria (including the pathogen Listeria monocytogenes), E. coli (including the pathogen E. coli 0157:H7) Bacillus cereus, Lactobacillus, and Pseudomonas fluorescens. Once the microbe is selected, information regarding the specific microbe is then obtained and provided to the data storage area. Some of this information may be publicly available, while other information is specific to the particular supply chain or segment of the supply chain (i.e. food processor). This information may include expected levels of customer complaints including spoilage, packaging, quality complaints; expected patterns of microbial growth at each food step (i.e. farm level, processor, retailer); lag and growth phases of the microbe; likelihood of microbial contamination at each food processing step; and acceptable threshold levels for the microbe in the food or environment as the level of concern can vary between segments and intended consumer. For example, consumers who are immunocompromised, those who are pregnant or living with HIV, or certain market segments, such as hospital patients, would have varying acceptable microbial levels in their food products.

B. Economic Data:

Economic data that may be inputted into the system varies depending on the particular food supply chain. Examples of economic parameters include overall revenues generated by the food supply chain; overall costs; revenues and costs for each major food handling step and each food processing step; energy costs; overall profitability and profitability of each food processing step; quality costs; cold chain time; inventory levels; human resources required at each food processing step; shift schedules; margins; overhead costs; production values; elapsed time; and production yields.

C. Process Steps Data:

The data relating to the food process steps can comprise one or more process parameters such as: slaughter; transportation of food; handling of food; cooking/processing of the food; grinding; inventory storage; warehousing; product testing; hold and release programs; border inspections; temperature of the food; contaminated raw materials; processing time to carry out each food processing step; capacity of each food processing step; water usage; type of equipment used; and product shelf life.

The Farm:

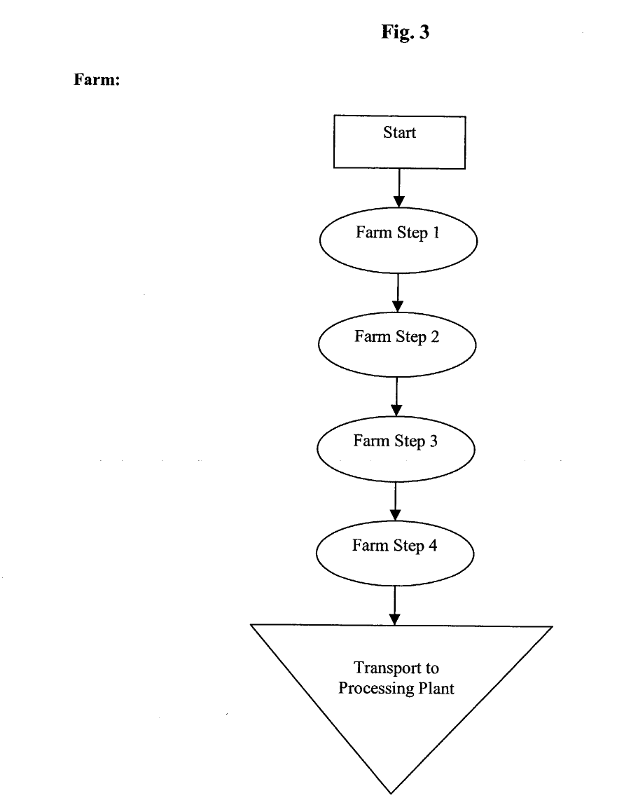

With reference to FIG. 3, in the preferred embodiment of the method of the present invention, namely a meat processing supply chain, the first major food handling step is at the farm. Here, the food processing steps may include raising the cattle, feeding the cattle, slaughtering, packaging, and storaging/warehousing the slaughtered cattle if the slaughtering does not take place at the processing level. Once the farm processing steps are completed, the slaughtered cattle are transported to the processing plant. Many parameters may affect the presence and growth of microbes at the farm. These may include the type of food fed to the cattle, sanitation conditions during rearing and slaughtering, temperature at the warehouse, temperature in the transport vehicles, time required to transport the slaughtered cattle to the processing plant, cost of packaging, etc.

The Processing Plant:

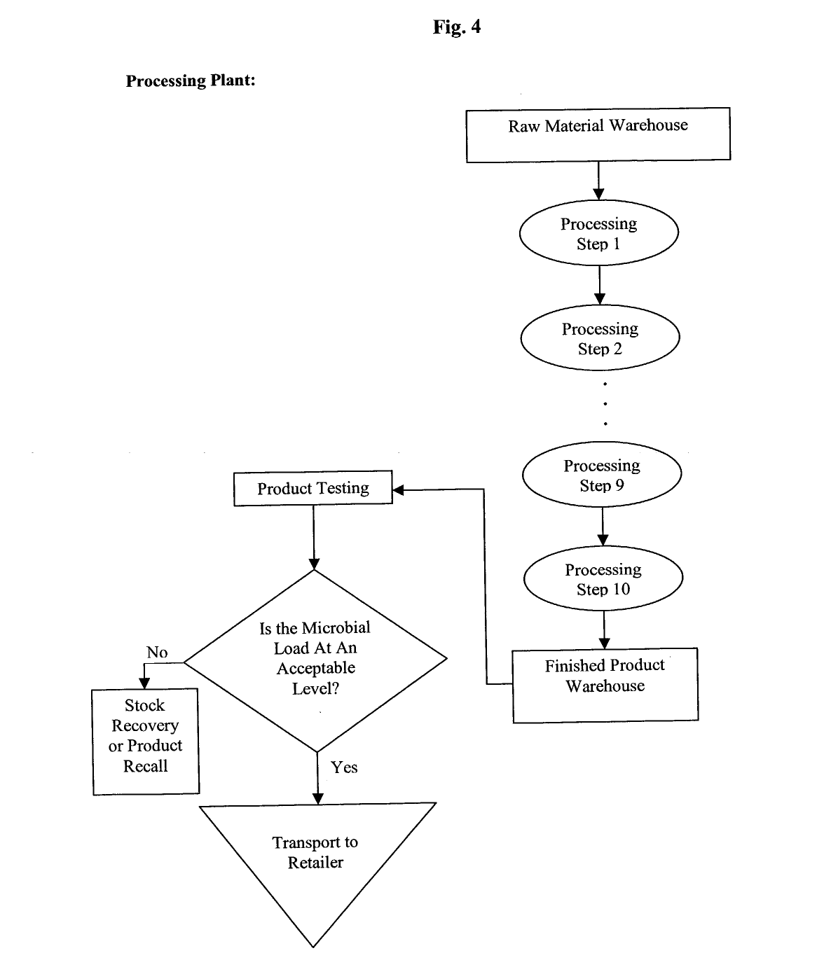

FIG. 4 illustrates the second major food handling step, namely the processing plant. Here, the carcass (raw material) may be initially stored in a warehouse prior to processing, thus it must be unloaded from the transport vehicles and moved to the warehouse. The carcass is then subjected to various processing steps, which may include cutting of the meat, deboning, grinding, pickling, cooking, packaging, etc. At the processing plant, there typically is a testing procedure in place where the finished processed meat is tested for the presence and level of microbes. If the numbers of microbes present in the processed meat is above a level or incidence of concern, the product is destroyed and/or recalled from the retailer in case some product had already been shipped to the retailer.

If the testing procedure reveals an acceptable microbial load in the finished product, the food product is moved to a finished product warehouse for temporary storage until it is loaded on a transport vehicle for transportation to a retailer.

Examples of parameters present at the processing plant that may affect the presence and growth of microbes include temperature of the raw material and finished product warehouses, equipment used for processing the meat, transportation from the raw material warehouse to the first processing step, cooking temperatures, sanitation procedures at each processing step, packaging procedures, accuracy of testing procedures, shift schedules for employees, etc.

The Retailer:

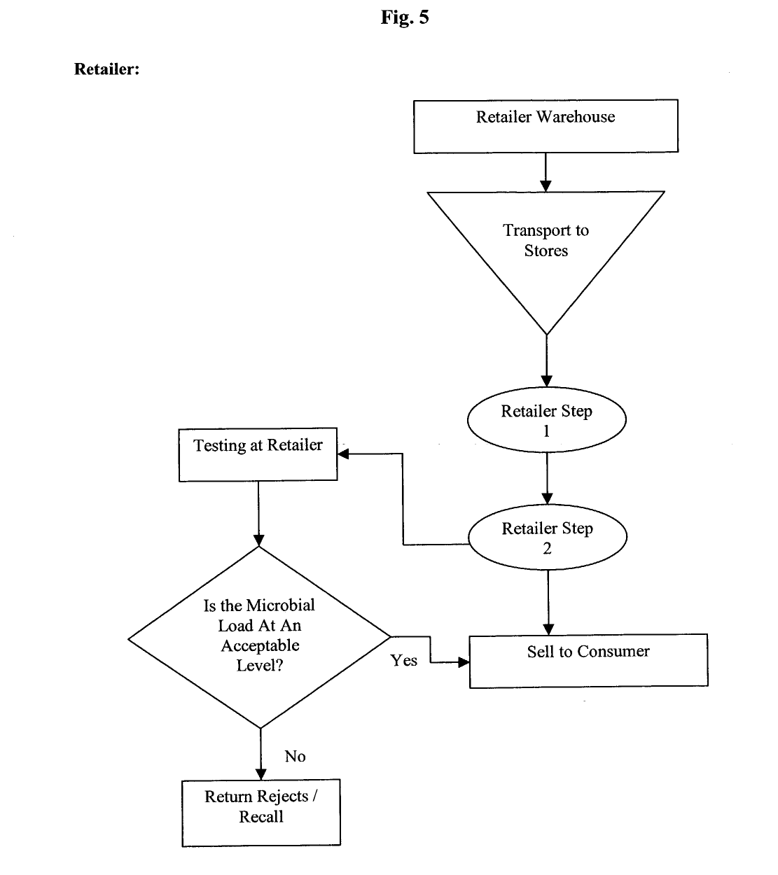

FIG. 5 illustrates the various processing steps that may occur at the retailer. Here again, the processed food product must first be unloaded from the transport vehicle and stored at the retailer's warehouse. It is then transported to the retailer's individual stores where it may be stored once again prior to being placed on the store shelves. The retailer may optionally have its own testing procedure in place, or may simply rely on any “best before” dates appearing on the food's packaging. Eventually, the food product is sold to the consumer.

The temperature of the food product at various retailer steps is a critical parameter. Other parameters of importance include average time the food product is warehoused by the retailer or displayed on the store shelves, sanitation procedures at the stores, transportation time to the stores, holding temperatures during transportation, delivery, and awaiting stocking shelves, etc.

The Consumer:

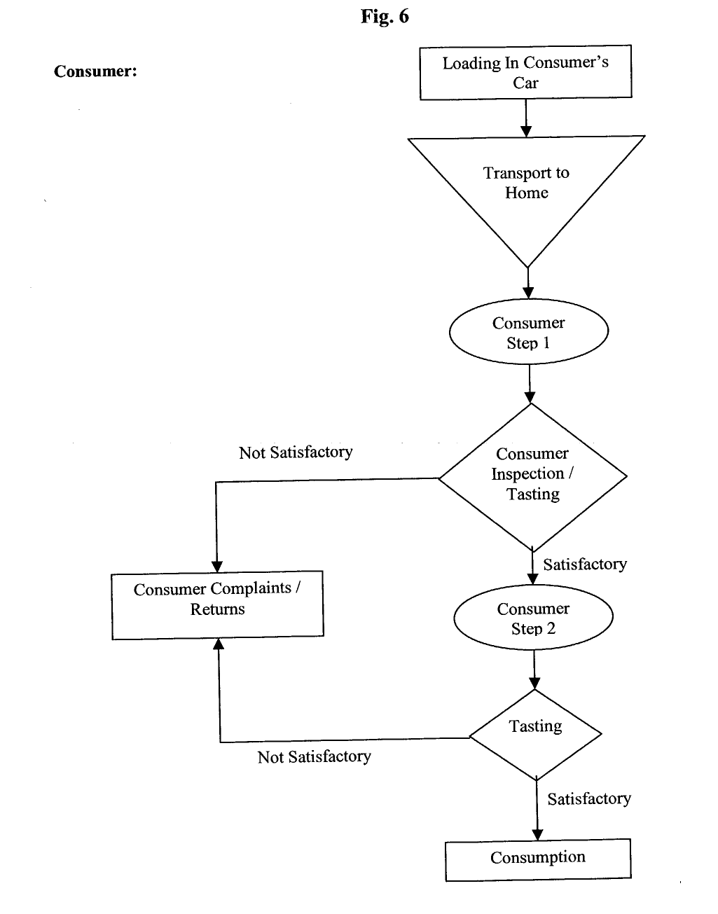

FIG. 6 illustrates the last major food handling step, namely by the consumer. Here, parameters of importance include the temperature at which the food product is stored, time for transportation, cooking preparation, storage time, general food handling practices, etc.

Once all the initial values for the major food handling steps, the food processing steps and the parameters are stored in the data storage area, one or more of these values may be varied and the digital processor then determines new values for the parameters resulting from this variance. For example, in the meat processing supply chain of FIGS. 3 to 6, a user can determine how a rise in warehousing temperature at the processing plant affects the presence and growth of microbes throughout the rest of the supply chain. This rise in storage temperature will likely result in lower energy costs, but may cause an increase in microbial load to unacceptable levels. Similarly, the simulation can be used to predict the effect of adding a new processing step at the processing plant, or the effect of a temporary work stoppage at the retailer, for example.

Several steps in the simulation may be repeated as mentioned above until a predetermined value for a chosen parameter is reached. For example, a user may decide to use a slower, less expensive means of transporting the finished food product from the processing plant to the retailer's warehouse. The simulation can be run for an indefinite amount of time, but is typically set for a predetermined amount of time, for example until six months have elapsed, to determine what impact this change would have on various business-related elements including microbial contamination in the food product, revenue growth and bottom line profitability.

The simulation method then allows the user to display any or all of the new parameter values that have been determined. These values are typically displayed on a computer screen, but other known display means may also be used, such as printing or transmission over a computer network.

Thus, in general, the method of the present invention may be used to determine how changes made to a food supply chain can affect productivity, production, and overall profitability, while still maintaining acceptable microbial levels in food product, be it finished product or product requiring further processing. All this can be done well before these changes are actually implemented. The simulation predicts the effects of changes within a food supply chain so that informed decisions can be made prior to any financial outlays by the user. The simulation method also assists the user in understanding the risks found in the food supply chain and can be used to try to minimize those risks.

Thus, with respect to a particular food supply chain, a list of data requirements must be identified so that a user can better define the initial values for the major food handling steps, the food processing steps and the parameters. These may include the following:

a. Obtain a general description of the production process flow;

b. Understand the available machines, equipment and production rates at different stages of the process;

c. Determine all relevant activities performed by human resources, safety and sanitation procedures, shift schedules, absenteeism, etc.;

d. Determine characteristics of different food products;

e. Obtain quality, yield and utility information;

f. Identify the data requirements that are related to risk factors within the system, including temperature, storage time, microbial contamination, etc.;

g. Identify and collect other relevant data, e.g. quality assurance of raw materials, different customer/product specific requirements, etc.;

h. Obtain cost, profits and other financial data; and

i. Determine current metrics in use and metrics that are to be kept track of, to identify both productivity and impact of risk factors in the system.

Therefore, the method of the present invention may be used, once all of the parameter values are inputted, to answer the intended questions, which typically are those relating to productivity, the impact of different risk factors on the bottom line, temperature impacts on the quality and shelf life of various food items, acceptable microbial levels at various stages in the food supply chain and the profitability of the overall operation.

Although the present invention has been shown and described with respect to its preferred embodiments and in the examples, it will be understood by those skilled in the art that other changes, modifications, additions and omissions may be made without departing from the substance and the scope of the present invention as defined by the attached claims.

What is claimed is:

1. In a digital processor, a method for simulating and modeling the presence and growth of a microbe in a food product through a food supply chain, wherein the food supply chain comprises a plurality of major food handling steps, a plurality of food processing steps within each of the major food handling steps and a plurality of parameters relating to the food supply chain and the microbe, the method comprising the steps of:
(a) providing a set of initial values for the major food handling steps in a data storage area;
(b) providing a set of initial values for the food processing steps in a data storage area;
(c) providing a set of initial values for the parameters in the data storage area;
(d) providing a set of equations that relate at least two of the parameters to each other;
(e) varying one or more of the initial values of the major food handling steps, the food processing steps or the parameters;
(f) executing a simulation routine, by the digital processor, using the set of equations to determine a second set of values for the parameters resulting from varying one or more of the initial values of the major food handling steps, the food processing steps or the parameters;
(g) storing the second set of values in the data storage area; and
(h) displaying one or more of the second set of values.

2. The method of claim 1, wherein steps (e) through (g) are repeated until a predetermined value is determined in step (f) for a chosen parameter.

3. The method of claim 1, wherein the plurality of parameters relating to the food supply chain and the microbe includes time/growth data for the microbe, economic data and process steps data.

4. The method of claim 3, wherein the time/growth data comprises one or more microbial parameters selected from the group consisting of: the type of microbe; expected levels of customer complaints; expected patterns of microbial growth at each food processing step; lag and growth phases of the microbe; likelihood of microbial contamination at each food processing step; and acceptable threshold levels for the microbe.

5. The method of claim 3, wherein the economic data comprises one or more economic parameters selected from the group consisting of: overall revenues; overall costs; revenues and costs for each food processing step; energy costs; overall profitability and profitability of each food processing step; cold chain time; inventory levels; human resources required at each food processing step; shift schedules; margins; overhead costs; production values; elapsed time; and production yields.

6. The method of claim 3, wherein the food process steps data comprises one or more process parameters selected from the group consisting of: slaughter step; transportation; handling; cooking/processing; grinding; inventory storage; warehousing; product testing; hold and release programs; border inspections; product temperature; contaminated raw materials; processing time to carry out each food processing step; capacity of each food processing step; water usage; type of equipment used; and product shelf life.

7. The method of claim 1, wherein the displaying step (h) includes displaying the one or more of the second set of values on a computer monitor, by printing, or by transmission over a computer network.

8. The method of claim 1, wherein the microbe is a pathogen or a spoilage organism.

9. The method of claim 8, wherein the pathogen or spoilage organism is selected from all microbial species, including various microbes such as Salmonella, Listeria, including Listeria monocytogenes), E. coli, including E. coli 0157:H7, Bacillus cereus, Lactobacillus, and Pseudomonas fluorescens.

10. The method of claim 2, wherein the chosen parameter is an economic parameter selected from the group consisting of: overall revenues; overall costs; revenues and costs for each food processing step; energy costs; overall profitability and profitability of each food processing step; cold chain time; inventory levels; human resources required at each food processing step; shift schedules; margins; overhead costs; production values; elapsed time; and production yields.

11. The method of claim 10, wherein the chosen parameter is elapsed time.

12. The method of claim 2, wherein the chosen parameter is the level of the microbe in the food product.

13. The method of claim 4, wherein the set of equations comprises at least one equation selected from the group consisting of: an equation to determine the levels of microbes as a function of temperature; an equation to determine profitability of the food supply chain; an equation to determine production yields; and combinations thereof.

14. The method of claim 5, wherein the set of equations comprises at least one equation selected from the group consisting of: an equation to determine the levels of microbes as a function of temperature; an equation to determine profitability of the food supply chain; an equation to determine production yields; and combinations thereof.

15. The method of claim 6, wherein the set of equations comprises at least one equation selected from the group consisting of: an equation to determine the levels of microbes as a function of temperature; an equation to determine profitability of the food supply chain; an equation to determine production yields; and combinations thereof.

16. The method of claim 15, wherein the food supply chain is selected from the group consisting of: a meat processing supply chain; the processing and packaging of poultry and pork; the growth, processing, packaging and sale of seafood, cereal, confections, and cooked, frozen and canned foods; the provision, preparation and sale of foods at a restaurant chain; and the preparation, delivery, sale and consumption of dairy products, such as cultured, industrial, fluid and ice cream.

17. The method of claim 16, wherein the food supply chain is a meat processing supply chain, and the major food handling steps comprise two or more of the following: raising cattle on a farm; delivery and slaughter of the cattle at an abattoir; delivery and processing of meat from the cattle at a processing plant; delivery and storage of the processed meat at a retailer; and delivery, preparation and consumption of the processed meat by a consumer.

18. The method of claim 17, wherein;
the raising of cattle on a farm comprises the food processing steps of raising the cattle, feeding the cattle, slaughtering the cattle to form a carcass, packaging the carcass, and storage/warehousing of the carcass;
the delivery and processing of the meat at a processing plant comprises the food processing steps of transporting the carcass to the processing plant, storing the carcass in a warehouse, cutting of meat from the carcass, deboning the meat, cooking to make a finished product, packaging the finished product, and a testing procedure to test the finished product for the presence and level of the microbe;
the delivery and storage of the processed meat at a retailer comprises the food processing steps of storing the finished product at the retailer's warehouse, transporting the finished product to the retailer's individual stores; storing the finished product at individual stores; placing the finished product on store shelves, and selling the finished product a consumer; and
the delivery, preparation and consumption of the processed meat by a consumer comprises the food processing steps of storing the finished product; preparing the finished product for consumption and consuming the finished product.
